(19) United States
(12) Patent Application Publication
(10) Pub. No.: US 2005/0212910 A1
(43) Pub. Date: Sep. 29, 2005

(54) Method and system for multidimensional virtual reality audio and visual projection

(76) Inventor: Manoj Kumar Singhal, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/809,223

(22) Filed: Mar. 25, 2004

(51) Int. Cl. H04N 7/00

(52) U.S. Cl. 348/36

(57) ABSTRACT

Disclosed herein is a method and system for multidimensional virtual reality audio and visual (MVR A/V) display. The MVR A/V system may be provided with an A/V capture system and an A/V display system. The MVR A/V system may also be provided with an A/V encoding system and an A/V decoding system. The MVR A/V system may also be provided with a capture storage system, a display storage system, and at least one ancillary storage system. The MVR A/V system may also be communicatively connected to a communication network, for example, the Internet. The MVR A/V method may provide capturing A/V information from a plurality of A/V receiving units, all of the A/V receiving units being focused upon at least a portion of the same zone or region. The MVR A/V method may also provide displaying the captured A/V information in a multidimensional virtual reality display system.

### RELATED APPLICATIONS

[Not Applicable]

### FEDERALLY SPONSORED RESEARCH OR DEVELOPMENT

[Not Applicable]

[MICROFICHE/COPYRIGHT REFERENCE]

[Not Applicable]

### BACKGROUND OF THE INVENTION

A live broadcast occurs when an audio/visual (A/V) device acquires A/V information and immediately transmits the acquired information to an A/V display device. For example, a television camera at the scene of a live event may acquire sounds and visual images from the event and immediately transmit those sounds and visual images to a satellite transmission truck.

From the satellite transmission truck, the acquired live information is transmitted to the broadcast studio. From the broadcast studio the information may be transmitted via a cable or over the airwaves to a viewer's display device, for example, a television.

Alternatively, the television camera may record the sounds and images onto a transportable media, for example, videotape. The videotape may be carried back to the television broadcast studio. Subsequently, the videotape may be played and the information transmitted via cable or over the airwaves to a viewer's display device.

Current audio/visual capture and display systems merely provide a two dimensional visual display and surround sound acquired/projected from discrete points along a two dimensional plane.

Further limitations and disadvantages of conventional and traditional approaches will become apparent to one of ordinary skill in the art through comparison of such systems with the present invention as set forth in the remainder of the present application with reference to the drawings.

### SUMMARY OF THE INVENTION

Aspects of the present invention may be found in a method of broadcasting multidimensional virtual reality audio and visual information. The method may comprise acquiring audio and visual information from a plurality of acquisition angles in a three dimensional space, processing the acquired audio and visual information for transmission, receiving the processed audio and visual information, and projecting the audio and visual information in a multidimensional virtual form from a plurality of projections angles in three dimensional space.

In an embodiment according to the present invention, the method may further comprise storing the audio and visual information.

In an embodiment according to the present invention, the method may further comprise communicating the audio and visual information via a communication network.

In an embodiment according to the present invention, processing the audio and visual information may further comprise at least one of encoding, decoding, compressing, and decompressing the audio and visual information. Processing may further comprise audio encoding and decoding and visual encoding and decoding. Audio encoding and decoding may comprise MPEG 1 level 3 processes and visual encoding and decoding may comprise MPEG 2 processes.

In an embodiment according to the present invention, the method may further comprise acquiring sound information surrounding and emanating from a subject and visual information surrounding and emanating from the subject.

In an embodiment according to the present invention, the method may further comprise acquiring sound and visual information from all possible angles around the subject. Visual features of an entirety of an exterior surface of a subject may be acquired multi-dimensionally.

In an embodiment according to the present invention, the method may further comprise producing a multi-dimensional surrounding visual representation and a multi-dimensional surrounding audio representation of a projected subject. The projected subject may be identical to a subject from which audio and visual information was previously acquired.

In an embodiment according to the present invention, the method may further comprise projecting holographic information from a plurality of holographic projector units interacting to form a multi-dimensional virtual reality region through at least one of light propagation, light cancellation, constructive interference, and destructive interference, of projected holographic information arriving from a plurality of angles simultaneously.

In an embodiment according to the present invention, the method may further comprise focusing and projecting holographic light information to a zone of projection. The holographic projection units may project holographic information to a location corresponding to an identical location where visual information was captured, creating a multi-dimensional virtual reality representation of the subject.

Aspects of the present invention may be found in a method of acquiring multidimensional audio and visual (A/V) information. The method may comprise acquiring audio and visual information from a multidimensional acquisition zone. The multidimensional acquisition zone may comprise a substantially continuous three dimensional field of capture. Acquiring audio and visual information may further comprise capturing audio and visual information from a plurality of angles at discrete positions in three dimensional space.

In an embodiment according to the present invention, the method may further comprise processing the captured audio and visual information for transmission. Processing the captured audio and visual information may further comprise at least one of encoding and compressing the captured audio and visual information.

In an embodiment according to the present invention, processing captured audio and visual information may further comprise encoding the audio information and encoding the visual information. Encoding the audio information may comprise encoding audio information by applying MPEG 1 level 3 encoding processes and encoding visual information may comprise encoding visual information by applying MPEG 2 visual encoding processes.

In an embodiment according to the present invention, the method may further comprise communicating the audio and visual information via at least one communication network.

In an embodiment according to the present invention, the method may further comprise storing the captured audio and visual information in at least one of a plurality of storage media devices.

In an embodiment according to the present invention, capturing audio and visual information may be performed using an A/V capture chamber.

In an embodiment according to the present invention, the A/V capture chamber may have a shape comprising at least one of spherical, rectangular, square, and ovoid.

In an embodiment according to the present invention, the method may further comprise acquiring sound information surrounding and emanating from a subject and acquiring visual information surrounding and emanating from the subject via a plurality of A/V receiver units.

In an embodiment according to the present invention, the method may further comprise deploying the plurality of A/V receiver units about an interior surface of the A/V capture chamber and acquiring sound and visual information from all possible angles around the subject.

In an embodiment according to the present invention, the method may further comprise focusing the A/V receiver units upon a capture acquisition region comprising a center of an interior of the A/V capture chamber.

In an embodiment according to the present invention, focusing may further comprise focusing each A/V receiver unit upon a portion of the capture acquisition region, and overlapping each adjacent A/V receiver unit acquisition region at least partially. The method may also comprise acquiring A/V information from the A/V receiver unit's acquisition region and overlapping portions of adjacent A/V receiver units' acquisition regions.

In an embodiment according to the present invention, the A/V receiver units may comprise at least one of a visual capture device and an audio capture device.

In an embodiment according to the present invention, the audio capture device and the visual capture device may be at least one of connected devices and separate devices.

In an embodiment according to the present invention, the visual capture device may comprise at least one video camera and the audio capture device may comprise at least on microphone.

In an embodiment according to the present invention, the method may further comprise capturing visual features of an entirety of an exterior surface of a subject by the plurality of A/V receiver units in combination multi-dimensionally and capturing audio information emanating from the subject by the plurality of A/V receiver units in combination multi-dimensionally.

In an embodiment according to the present invention, the method may further comprise combining additional ancillary A/V information with the acquired A/V information.

In an embodiment according to the present invention, the additional ancillary A/V information may comprise at least one of music, graphs, pictures, tables, documents, and backgrounds.

Aspects of the present invention may be found in a method of displaying and projecting multidimensional audio and visual (A/V) information. The method may comprise projecting audio and visual information into a multidimensional display region. The multidimensional display region may comprise a focused field of projection. Displaying audio and visual information may further comprise projecting audio and visual information from a plurality of projection angles at discrete positions in three dimensional space.

In an embodiment according to the present invention, the method may further comprise processing received audio and visual information. Processing may comprise at least one of decompressing and decoding audio and visual information.

In an embodiment according to the present invention, processing audio and visual information may further comprise audio decoding and video decoding. Audio decoding may comprise MPEG 1 level 3 decoding processes and video decoding may comprise MPEG 2 decoding processes.

In an embodiment according to the present invention, the method may further comprise projecting the audio and visual information in a multidimensional virtual form into a corresponding multidimensional projection zone.

In an embodiment according to the present invention, the method may further comprise storing audio and visual information in a plurality of storage media devices.

In an embodiment according to the present invention, the method may further comprise receiving audio and visual information from at least one communication network.

In an embodiment according to the present invention, the A/V display system may comprise an A/V display chamber.

In an embodiment according to the present invention, the A/V display chamber may have a shape comprising at least one of spherical, rectangular, square, and ovoid. The A/V display chamber may be selected from one of a room and a stage.

In an embodiment according to the present invention, the method may further comprise processing visual information. Processing visual information may further comprise enabling a video display engine to transform the visual information into a video output signal.

In an embodiment according to the present invention, the method may further comprise transmitting the video output signal to a video projection unit.

In an embodiment according to the present invention, processing the visual information may further comprise enabling a holographic display engine to transform the visual information to a holographic output signal.

In an embodiment according to the present invention, the method may further comprise transmitting the holographic output signal to a holographic projection unit.

In an embodiment according to the present invention, the method may further comprise processing audio information and transmitting the audio information via an audio output signal.

In an embodiment according to the present invention, the method may further comprise transmitting the audio output signal to an audio projection unit.

In an embodiment according to the present invention, the method may further comprise at least one of transmitting an audio output signal and one of a video output signal and a holographic output signal combined together and transmitting an audio output signal and one of a video output signal and a holographic output signal separately.

In an embodiment according to the present invention, receiving and projecting may be performed by a plurality of video projection units for displaying the video output signal and a plurality of audio projection units for projecting the audio output signal. A plurality of A/V display units may be distributed around an interior surface of an A/V display chamber.

In an embodiment according to the present invention, the method may further comprise focusing and directing audio information and projected holographic information upon a center region of the A/V display chamber producing a multi-dimensional surrounding visual and multi-dimensional surrounding audio representation of a projected subject.

In an embodiment according to the present invention, the method may further comprise projecting holographic information from a plurality of holographic projector units forming a multi-dimensional virtual reality region through at least one of light propagation, light cancellation, constructive interference, and destructive interference, of the projected holographic information arriving from a plurality of angles around an entirety of the A/V display chamber simultaneously.

In an embodiment according to the present invention, focusing and projecting the holographic information may further comprise focusing and projecting the holographic information from a plurality of discrete angles and overlapping zones of projection.

In an embodiment according to the present invention, the method may further comprise projecting holographic information to the zone of projection via a plurality of holographic projection units. The holographic projection units may project holographic information to a location creating a multi-dimensional virtual reality representation of a subject.

In an embodiment according to the present invention, the method may further comprise playing audio information via a plurality of audio playback units. Each of the audio playback units may comprise at least one speaker. The audio playback units may focus and project audio information to create a multidimensional virtual audio representation of a subject's sound information and speech.

Aspects of the present invention may be found in a multidimensional virtual reality audio and visual (A/V) system comprising an A/V capture system for acquiring audio and visual information from a multidimensional acquisition zone and an A/V encoding system. The A/V encoding system may process the acquired audio and visual information for transmission.

In an embodiment according to the present invention, the system may further comprise a plurality of storage media devices for storing audio and visual information.

In an embodiment according to the present invention, the storage media devices for storing audio and visual information may further comprise at least one of a stationary storage device and a mobile storage device.

In an embodiment according to the present invention, the system may further comprise the multidimensional virtual reality audio and visual system may be communicatively coupled to at least one communication network wherein audio and visual information may be communicated between one of the A/V encoding system and at least one of a plurality of storage media devices for storing audio and visual information.

In an embodiment according to the present invention, the audio and visual information captured by the A/V capture system may be at least one of encoded and compressed by the A/V encoding system.

In an embodiment according to the present invention, the A/V capture system may comprise an A/V capture chamber.

In an embodiment according to the present invention, the A/V capture chamber may have a shape comprising at least one of spherical, rectangular, square, and ovoid.

In an embodiment according to the present invention, the A/V capture chamber may be adapted to acquire sound information surrounding and emanating from a subject and visual information surrounding and emanating from the subject via a plurality of A/V receiver units.

In an embodiment according to the present invention, the plurality of A/V receiver units may be deployed about an interior surface of the A/V capture chamber to acquire sound and visual information from all possible angles around the subject.

In an embodiment according to the present invention, the A/V receiver units may be focused upon a capture acquisition region comprising a center of an interior of the A/V capture chamber.

In an embodiment according to the present invention, each A/V receiver unit may be focused upon a portion of the capture acquisition region, and each A/V receiver unit may be arranged to acquire A/V information from an A/V receiver unit acquisition region at least partially overlapping an adjacent A/V receiver unit's acquisition region.

In an embodiment according to the present invention, the A/V receiver units may comprise at least one of a video capture device and an audio capture device.

In an embodiment according to the present invention, the audio capture device and the video capture device may be at least one of connected devices and separate devices.

In an embodiment according to the present invention, the video capture device may comprise at least one video camera and the audio capture device may comprise at least on microphone.

In an embodiment according to the present invention, visual features of an entirety of an exterior surfaces of a subject may be captured by the plurality of A/V receiver units in combination multi-dimensionally, and audio information emanating from the subject may be captured by the plurality of A/V receiver units in combination multi-dimensionally.

In an embodiment according to the present invention, additional A/V information may be combined with the acquired A/V information from the A/V receiver units.

In an embodiment according to the present invention, the additional A/V information may comprise at least one of music, graphs, pictures, tables, documents, and backgrounds.

In an, embodiment according to the present invention, the A/V encoding system processing received audio and visual information may further comprise audio encoding and video encoding. Audio encoding may comprise MPEG 1 level 3 encoding processes and video encoding may comprise MPEG 2 decoding processes.

Aspects of the present invention may be found in a multidimensional virtual reality audio and visual (A/V) system comprising an A/V decoding system. The A/V decoding system may process received audio and visual information. The system may also comprise an A/V display system. The A/V display system may project the audio and visual information in a multidimensional virtual form in a corresponding multidimensional projection zone.

In an embodiment according to the present invention, the system may further comprise a plurality of storage media devices for storing audio and visual information.

In an embodiment according to the present invention, the storage media devices for storing audio and visual information may further comprise at least one of a stationary storage device and a mobile storage device.

In an embodiment according to the present invention, the multidimensional virtual reality audio and visual system may be communicatively coupled to at least one communication network. Audio and visual information may be communicated between one of the A/V decoding system, and at least one of a plurality of storage media devices for storing audio and visual information.

In an embodiment according to the present invention, the A/V decoding system processing received audio and visual information may further comprise audio decoding and video decoding. Audio decoding may comprise MPEG 1 level 3 decoding processes and video decoding may comprise MPEG 2 decoding processes.

In an embodiment according to the present invention, the A/V decoding system processing received visual information may further comprise enabling a video display engine to transform the visual information to a video output signal.

In an embodiment according to the present invention, the video output signal may be transmitted to a video projection unit.

In an embodiment according to the present invention, the A/V decoding system processing received visual information may further comprise enabling a holographic display engine to transform the visual information to a holographic output signal.

In an embodiment according to the present invention, the holographic output signal may be transmitted to a holographic projection unit.

In an embodiment according to the present invention, the system may further comprise means for transmitting the audio information via an audio output signal.

In an embodiment according to the present invention, the audio output signal may be transmitted to an audio projection unit.

In an embodiment according to the present invention, the system may further comprise an audio output signal and one of a video output signal and a holographic output signal being transmitted one of combined together and separately.

In an embodiment according to the present invention, the A/V display system may receive one of a combined holographic and audio output signal, a combined video and audio output signal, separate holographic and audio output signals, and separate video and audio output signals from the A/V decoding system.

In an embodiment according to the present invention, the A/V display system may comprise an A/V display chamber. The A/V display chamber may have a shape comprising one of spherical, rectangular, square, and ovoid. The A/V display chamber may further comprise one of a room and a stage.

In an embodiment according to the present invention, the A/V display chamber may comprise a plurality of video projection units for displaying the video output signal and a plurality of audio projection units for projecting the audio output signal.

In an embodiment according to the present invention, the A/V display chamber may comprise a plurality of A/V display units distributed around an interior surface of the A/V display chamber.

In an embodiment according to the present invention, audio information and holographic information may be directed and focused upon a center region of the A/V display chamber producing a multi-dimensional surrounding visual and multi-dimensional surrounding audio representation of a projected subject. The projected subject may be identical to a subject from which A/V information was captured in a corresponding A/V capture chamber.

In an embodiment according to the present invention, projected holographic information from a plurality of holographic projector units interact forming a multi-dimensional virtual reality region through at least one of light propagation, light cancellation, constructive interference, and destructive interference, of the projected holographic information arriving from a plurality of angles around an entirety of the A/V display chamber simultaneously.

In an embodiment according to the present invention, the projected holographic information may be focused and projected from a plurality of corresponding angles and zones of projection.

In an embodiment according to the present invention, the system may further comprise an A/V display unit. The A/V display unit may comprise a plurality of holographic projection units projecting holographic light information to the zone of projection. The holographic projection units may project holographic information creating a multi-dimensional virtual reality representation of the subject.

In an embodiment according to the present invention, the A/V display unit may also comprise a plurality of audio playback units. The audio playback units may comprise at least one speaker. The audio playback units may project audio information to create a multi-dimensional virtual audio representation of a subject's sound information and speech.

Aspects of the present invention may be found in a multidimensional virtual reality audio and visual (A/V) system comprising an A/V capture system for acquiring audio and visual information from a multidimensional acquisition zone, an A/V encoding system for processing the acquired audio and visual information for transmission, an A/V decoding system for processing received audio and visual information, and an A/V display system for projecting the audio and visual information in a multidimensional virtual form in a corresponding multidimensional projection zone.

In an embodiment according to the present invention, the system may further comprise a plurality of storage media devices for storing audio and visual information.

In an embodiment according to the present invention, the storage media devices for storing audio and visual information may further comprise at least one of a stationary storage device and a mobile storage device.

In an embodiment according to the present invention, the multidimensional virtual reality audio and visual system may be communicatively coupled to at least one communication network. Audio and visual information may be communicated between one of the A/V encoding system, the A/V decoding system, and at least one of a plurality of storage media devices for storing audio and visual information.

In an embodiment according to the present invention, the A/V capture system and the A/V display system may be located at different geographic locations.

In an embodiment according to the present invention, the A/V capture system and the A/V display system may be co-located at different geographic locations.

In an embodiment according to the present invention, the A/V encoding system and the A/V decoding system may be located at different geographic locations.

In an embodiment according to the present invention, the A/V encoding system and the A/V decoding system may be co-located at a plurality of different geographic locations.

In an embodiment according to the present invention, the A/V capture system and the A/V encoding system may be co-located at a first location and the A/V decoding system and the A/V display system may be co-located at a second location. The first location may be geographically distinct from the second location.

In an embodiment according to the present invention, additional A/V information may be combined with the acquired A/V information from the A/V receiver units.

In an embodiment according to the present invention, the additional A/V information may comprise at least one of music, graphs, pictures, tables, documents, and backgrounds.

In an embodiment according to the present invention, the A/V decoding system processing received audio and visual information may further comprise audio decoding and video decoding. Audio decoding may comprise MPEG 1 level 3 decoding processes and video decoding may comprise MPEG 2 decoding processes.

In an embodiment according to the present invention, the A/V decoding system processing received visual information may further comprise enabling a video display engine to transform the visual information to a video output signal.

In an embodiment according to the present invention, the video output signal may be transmitted to a video projection unit.

In an embodiment according to the present invention, the A/V decoding system processing received visual information may further comprise enabling a holographic display engine to transform the visual information to a holographic output signal.

In an embodiment according to the present invention, the holographic output signal may be transmitted to a holographic projection unit.

In an embodiment according to the present invention, the A/V decoding system processing received audio information may further comprise transmitting the audio information via an audio output signal.

In an embodiment according to the present invention, the audio output signal may be transmitted to an audio projection unit.

In an embodiment according to the present invention, an audio output signal and one of a video output signal and a holographic output signal may be transmitted one of combined together and separately.

In an embodiment according to the present invention, the A/V display system may receive one of a combined holographic and audio output signal, a combined video and audio output signal, separate holographic and audio output signals, and separate video and audio output signals from the A/V decoding system.

In an embodiment according to the present invention, the A/V display system may comprise an A/V display chamber. The A/V display chamber may have a shape comprising one of spherical, rectangular, square, and ovoid. The A/V display chamber may further comprise one of a room and a stage.

In an embodiment according to the present invention, the A/V display chamber may comprise a plurality of video projection units for displaying the video output signal and a plurality of audio projection units for projecting the audio output signal.

In an embodiment according to the present invention, the A/V display chamber may comprise a plurality of A/V display units distributed around an interior surface of the A/V display chamber.

In an embodiment according to the present invention, audio information and holographic information may be directed and focused upon a center region of the A/V display chamber producing a multi-dimensional surrounding visual and multi-dimensional surrounding audio representation of a projected subject. The projected subject may be identical to a subject from which the A/V information was captured in the A/V capture chamber.

In an embodiment according to the present invention, projected holographic information from a plurality of holographic projector units interact forming a multi-dimensional virtual reality region through at least one of light propagation, light cancellation, constructive interference, and destructive interference, of the projected holographic information arriving from a plurality of angles around an entirety of the A/V display chamber simultaneously.

In an embodiment according to the present invention, the projected holographic information may be focused and projected from a plurality of corresponding angles and zones of projection corresponding to angles and zones of acquisition by the A/V receiving units of A/V capture chamber.

In an embodiment according to the present invention, the system may further comprise an A/V display unit. The A/V display unit may comprise a plurality of holographic projection units projecting holographic information to the zone of projection. The holographic projection units may project holographic information to a location corresponding to an identical location in the A/V capture chamber where visual information was captured and creating a multi-dimensional virtual reality representation of the subject.

In an embodiment according to the present invention, the A/V display unit may also comprise a plurality of audio playback units. The audio playback units may comprise at least one speaker. The audio playback units may project audio information to an identical location in the A/V display chamber where the audio information was acquired in the A/V capture chamber. The plurality of audio playback units may be focused to project audio information to create a multi-dimensional virtual audio representation of a subject's sound information and speech.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram illustrating a multidimensional virtual reality audio and visual system in accordance with an embodiment of the present invention;

FIG. 2 is a pictorial representation of an audio and visual capture system in accordance with an embodiment of the present invention;

FIG. 3 is a pictorial representation of an audio and video receiver unit in accordance with an embodiment of the present invention;

FIG. 4 is a block diagram illustrating an audio and video encoding system in accordance with an embodiment of the present invention;

FIG. 5 is a block diagram illustrating an audio and video decoding system in accordance with an embodiment of the present invention;

FIG. 6 is a pictorial representation of an audio and video display system in accordance with an embodiment of the present invention;

FIG. 7 is a pictorial representation of an audio and video display unit in accordance with an embodiment of the present invention.

### DETAILED DESCRIPTION OF THE INVENTION

Current audio/visual capture and display systems merely provide a two dimensional visual display and surround sound acquired/projected from discrete points along a two dimensional plane. In contrast to the current audio/visual capture and display systems, in an embodiment according to the present invention, a multi-dimensional, i.e., at least three dimensional (3-D) audio/visual capture and projection systems are disclosed herein. The multi-dimensional audio/visual capture system is adapted to acquire audio and visual information for substantially continuous three dimensional points. The multi-dimensional audio/visual projection system is adapted to project three dimensional continuous audio and visual projections forming a three dimensional virtual reality recreation of the subject acquired by the multi-dimensional audio/visual capture system.

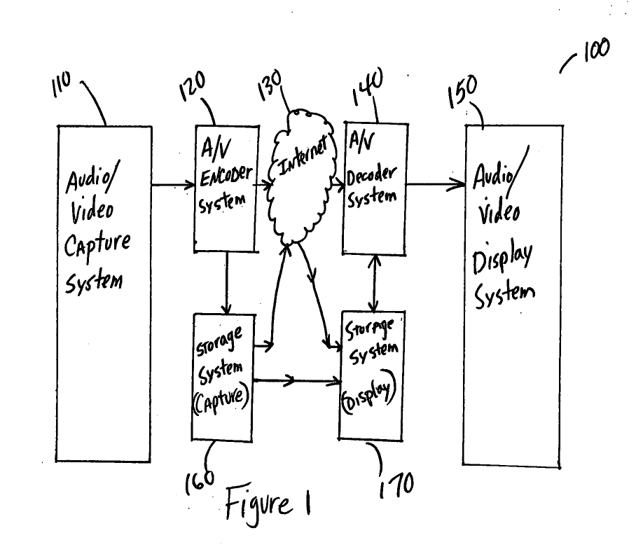

FIG. 1 is a block diagram illustrating a multidimensional virtual reality audio and visual system 100 in accordance with an embodiment of the present invention. The multidimensional virtual reality audio and visual system 100 illustrated in FIG. 1 may comprise an audio and visual capture system 110 and an audio and visual display system 150. The audio and visual capture system 110 and the audio and visual display system 150 may be located at different locations. For example, the audio and visual capture system 110 may be located in a first city and the audio and visual display system 150 may be located in a second distantly located city.

The multidimensional virtual reality audio and visual system 100 may also comprise an audio and visual (A/V) encoding system 120 and an A/V decoding system 140. The A/V encoding system 120 may be located at the same location as the A/V capture system 110 or may be located at a different location. The A/V decoding system 140 may be located at the same location as the A/V display system 150 or may be located at a different location.

The multidimensional virtual reality A/V system 100 may also comprise a capture storage system 160 and a display storage system 170. The capture storage system 160 may be located at the same location as the A/V capture system 110 or may be located at a different location. The display storage system 170 may be located at the same location as the A/V display system 150 or may be located at a different location.

The multidimensional virtual reality A/V system 100 may also be communicatively connected to a communications network 130, such as the Internet.

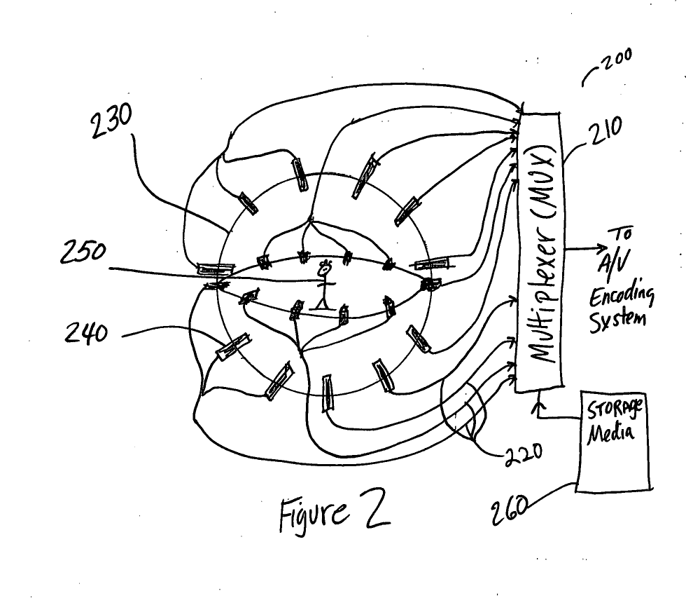

Aspects of the present invention may be found in a multidimensional virtual reality A/V system 100 adapted to capture A/V information from a first location using the A/V capture system 110. The A/V capture system 110 will be described in detail below with reference to FIG. 2.

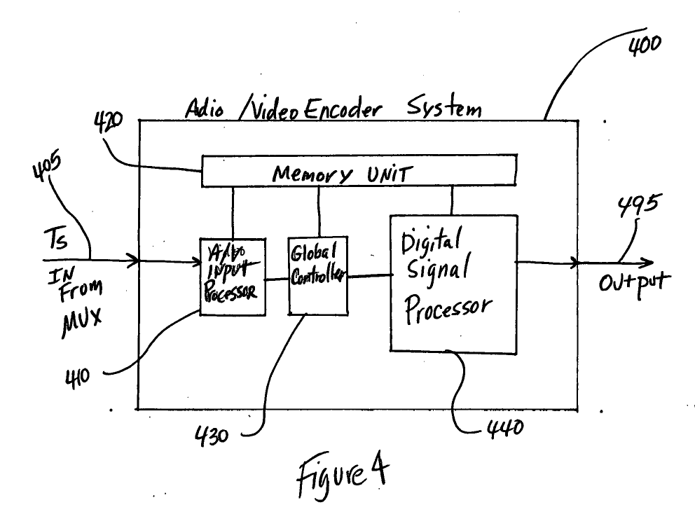

In an embodiment according to the present invention, the A/V information captured using the A/V capture system 110 may be encoded and/or compressed by the A/V encoding system 120. The A/V encoding system 120 will be described in detail below with reference to FIG. 4.

In an embodiment according to the present invention, the A/V information may be encoded and compressed for transmission to the capture storage system 160, the display storage system 170, to the communications network 130. The A/V information may be stored for later transmission and/or playback on, for example, a computer hard drive or other stationary storage media. The A/V information may also be stored on a mobile storage media, such as, a CDROM, DVDROM, floppy disk, or other transportable mobile storage media.

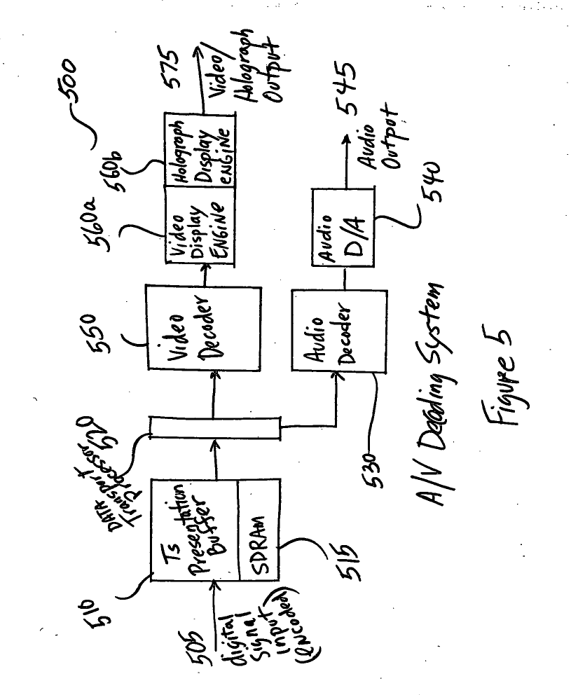

In an embodiment according to the present invention, the encoded A/V information may be transmitted to the communication network 130, for example, the Internet, and subsequently received at the A/V decoding system 140. The A/V decoding system will be described in detail below with reference to FIG. 5.

In an embodiment according to the present invention, encoded A/V information may be stored in encoded form and transmitted to the display storage system 170. Alternatively, the encoded A/V information may be decoded at the A/V decoding system 140 and then transmitted to the display storage system 170 for storage in decoded form. The display storage system 170 may comprise a stationary storage device, such as a computer hard drive or other stationary storage media, or alternatively, the display storage system may comprise a mobile storage media, such as a CDROM, DVDROM, floppy disk, or other transportable storage media.

In an embodiment according to the present invention, the encoded A/V information may be stored on a mobile storage media in encoded form by the capture storage system 160 and transported to and stored upon the display storage system 170, wherein the encoded A/V information may be transmitted to the A/V decoding system 140 for decoding, and then transmitted back to the display storage system 170 for storage in decoded form.

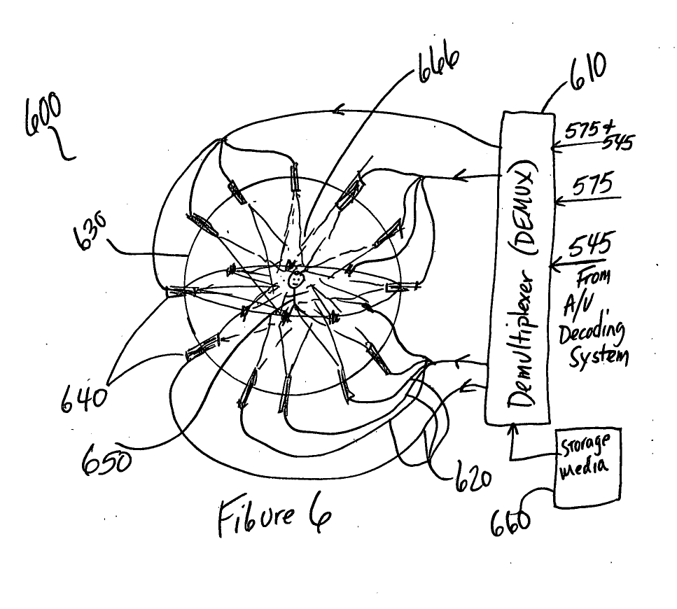

In an embodiment according to the present invention, the decoded A/V information may be transmitted to the A/V display system 150 for display. The A/V display system 150 will be described in detail below with reference to FIG. 6.

Aspects of the present invention may also be found in a multidirectional multidimensional virtual reality A/V system, wherein at each A/V capture location a corresponding A/V display system may also be co-located, and at each A/V display location a corresponding A/V capture system may also be co-located.

In an embodiment according to the present invention, the multidirectional multidimensional virtual reality A/V system provides multi-way A/V transmission/reception/acquisition/display capacity.

In an embodiment according to the present invention, each of the respective co-located A/V capture and A/V display locations may also comprise A/V encoding systems, A/V decoding systems, capture storage systems, and display storage systems, thus providing for simultaneous transmission/reception/capture/display of A/V information.

FIG. 2 is a pictorial representation of an audio and visual (A/V) capture system 200 in accordance with an embodiment of the present invention. The A/V capture system 200 illustrated in FIG. 2 may comprise a spherical A/V capture chamber 230, for example. Although a spherical A/V capture chamber 230 is described herein for purpose of explanation, the invention is not limited to a spherical chamber, i.e., rectangular, square, elliptical, etc. chambers may also be used, as desired.

In an embodiment according to the present invention, the spherical A/V capture chamber 230 may be adapted to provide acquisition of sound information surrounding and emanating from a subject 250 and visual information surrounding and emanating from the subject 250 via a plurality of A/V receiver units 240.

In an embodiment according to the present invention, the plurality of A/V receiver units 240 may be optimally stationed/deployed (uniformly or irregularly) about the circumference of the interior surface of the spherical A/V capture chamber 230 to capture/acquire sound and visual information from all possible angles around the subject 250.

The A/V receiver units 240 may be focused, both for visual reception and audio reception, upon a zone/region comprising the center of the interior of the spherical A/V capture chamber 230. Sound and visual information from the acquisition zone/region of a particular A/V receiver unit 240 may be acquired by aiming and focusing the A/V receiver unit 240 at a particular location within the center of the interior of the A/V capture chamber 230. The acquisition zone/region may also be arranged such that the acquisition zone/region of each adjacent A/V receiver unit at least overlaps slightly the acquisition zones/regions of adjacent A/V receiver units.

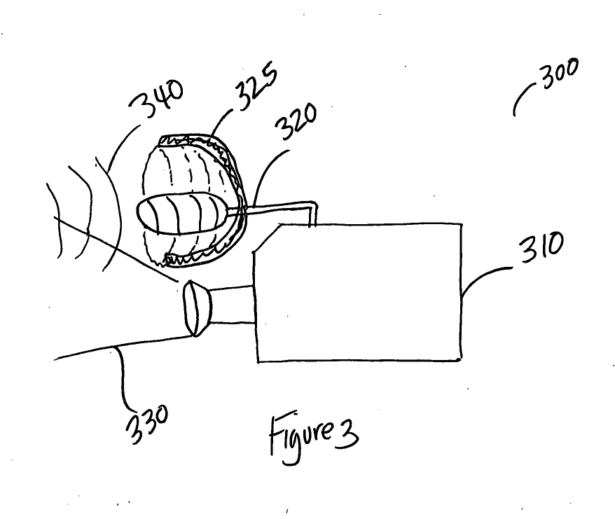

The A/V receiver units 240 may comprise a video capture device, such as a video camera(s), and an audio capture device, such as a microphone(s). The A/V receiver units 240 will be described in detail in the description of FIG. 3 below.

In an embodiment according to the present invention, a subject 250, for example, a human being, may be positioned in the zone/region comprising the center of the interior of the spherical A/V capture chamber 230. The A/V receiver units 240 are adapted to capture that portion of the subject 250 (audio and visual information) that is disposed within the zone/region of acquisition of each particular A/V receiver unit 240.

In an embodiment according to the present invention, by arranging a plurality of A/V receiver units 240 about the circumference of the entirety of the interior surface of the spherical A/V capture chamber 230, and wherein each of the A/V receiver units 240 is focused upon the center of the interior of the A/V capture chamber 230 to capture audio and visual information corresponding to particular respective zones/regions of acquisition.

In an embodiment according to the present invention, visual features of a entirety of the exterior surfaces of the subject 250 are captured by the plurality of surrounding A/V receiver units 240 in combination 3-dimensionally, and the audio information emanating from the subject are also captured by the plurality of A/V receiver units 240 in combination 3-dimensionally, regardless of which direction the subject turns or speaks.

In an embodiment according to the present invention, the A/V information acquired/captured by the A/V receiver units 240 may comprise a plurality of video elementary streams and a plurality of audio elementary streams that may be transmitted over a plurality of channels. The plurality of audio and video elementary streams may be directed through wires 220, or wirelessly, if desired, to a multiplexer (MUX) 210.

In an embodiment according to the present invention, in the MUX 210, the plurality audio and video elementary streams are accumulated, combined, and coordinated into transport packets and a transport stream for transmission to the A/V encoding system, as described with reference to FIG. 4 below.

In an embodiment according to the present invention, additional A/V information may also be submitted to the MUX 210 and combined with the video and audio elementary streams from the A/V receiver units 240. The additional A/V information may be stored and transferred from an ancillary storage media 260, such as a computer hard drive, for example. The additional A/V information may comprise one or more of music, graphs, pictures, tables, documents, backgrounds, and other information, etc., desirable to be included in the A/V transmission.

FIG. 3 is a pictorial representation of an audio/visual (A/V) receiver unit 300 in accordance with an embodiment of the present invention. In an embodiment according to the present invention, the A/V receiver unit 300, 240 in FIG. 2 may comprise a visual capture device 310, such as a video camera(s), and an audio capture device 320, such as a microphone(s).

While the A/V capture devices are shown connected together in FIG. 3 for purpose of example, the audio capture units and the video capture units may also be separate and distinct devices in an embodiment according to the present invention.

In another embodiment according to the present invention, the audio capture units and video capture units may be disposed at different and distinct locations about the circumference of the interior of the spherical A/V capture chamber 230 disclosed in FIG. 2. The audio and video capture units, even when disposed separately about the spherical A/V capture chamber, may be arranged to provide A/V information capture within the zone/region surrounding the entirety of the subject.

In an embodiment according to the present invention, A/V receiver units (e.g., 300) may be adapted to visually and audibly focus on a particular zone/region for acquiring A/V information originating from within each A/V receiver units' particular zone/region of acquisition.

For example, in an embodiment according to the present invention, the audio capture device 320 (e.g., a microphone) may be adapted to receive and capture audio information (sound wave energy 340) emanating from its respective particular zone/region of acquisition. Additionally, the video capture device 310 (e.g., a video camera) may be adapted to receive and capture video information (light wave energy 330) emanating from its respective particular zone/region of acquisition.

In an embodiment according to the present invention, the audio capture device 320 may comprise at least one of a single microphone and a multi-microphone system, as desired. Additionally, the microphone system may comprise at least one of an omnidirectional microphone and a unidirectional microphone. The audio capture device 320 may also be provided with an audio focusing shroud 325, or audio focusing cone, to facilitate focusing of received audio information from a particular zone/region of audio acquisition.

In an embodiment according to the present invention, the video capture device 310 may comprise at least one of a single aperture optical input (light capture arrangement, e.g., one video camera) or a multi-aperture optical input (light capture arrangement, e.g., a plurality of video cameras) system for receiving light wave energy 330.

For example, the video capture device 310 may comprise a plurality of interchangeable lenses for focusing the video capture device at various locations. Alternatively, in an embodiment according to the present invention, the video capture device 310 may comprise an adjustable lens system, wherein by moving a single lens closer to or farther away from the light receiving aperture, or the subject, the video capture device 310 is able to change the location of focus within the zone/region of visual acquisition.

In an embodiment according to the present invention, the video capture device 310 may also comprise a plurality of video input apertures (lens) disposed at each video capture location about the spherical A/V capture chamber 230 (as illustrated in FIG. 2).

FIG. 4 is a block diagram illustrating an audio/visual (A/V) encoding system 400 in accordance with an embodiment of the present invention. The A/V encoding system 400 receives the multiplexed transport stream (Ts) 405 from the MUX 210, as illustrated in FIG. 2. The A/V encoder system 400 may at least comprise an A/V input processor 410, global controller 430, memory unit 420, and a digital signal processor 440.

In an embodiment according to the present invention, the multiplexed transport stream may, after being encoded and/or compressed, be output as a digital signal 495 as illustrated in FIG. 4. The digital output signal 495 may be in a form immediately ready for transmission to a communications network, e.g., the Internet, or to a storage media device for later access, transmission, decoding, decompressing, etc.

In an embodiment according to the present invention, the digital output signal 495 may be stored at the capture storage system 160, as illustrated in FIG. 1. At the capture storage system 160, the digital output signal 495 may be stored on a stationary storage media, such as a computer hard drive, or alternatively may be stored on a mobile storage media, such as a CDROM, DVDROM, floppy disk, etc. Subsequently, the digital output signal 495 from the A/V encoding system 400 may be transmitted from the capture storage system 160 to a communications network 130, such as the Internet, or transported to the display storage system 170.

In an embodiment according to the present invention, the digital output signal 495 may be directed to a display storage system 170, as illustrated in FIG. 1. At the display storage system 170, the digital output signal 495 may be saved on a stationary storage device, such as a computer hard drive, or alternatively may be stored on a mobile storage media, such as a CDROM, DVDROM, floppy disk, etc.

In an embodiment according to the present invention, the digital output signal 495 may be transmitted from the capture storage system 160 via the communication network 130 to an A/V decoding system 140, as illustrated in FIG. 1. The encoded digital output signal 495 may be decoded at the A/V decoding system 140 and transmitted to the display storage system 170 in a decoded form for storage and later playback.

FIG. 5 is a block diagram illustrating an audio/visual (A/V) decoding system 500 in accordance with an embodiment of the present invention. In an embodiment according to the present invention, the A/V decoding system 500 receives the encoded digital input signal 505 from at least one of the communications network 130, capture storage system 160, display storage system 170, etc.

According to an embodiment of the present invention, initially, the encoded digital input signal 505 may be received at a transport stream (Ts) presentation buffer 510, for example, which may comprise a random access memory device, such as SDRAM 515. The transport stream presentation buffer 510 may be adapted to direct the encoded digital input signal 505 to a data transport processor 520.

In an embodiment according to the present invention, in the data transport processor 520, the audio and visual components, which may have been randomly mixed together during transmission, are sorted for separate decoding, e.g., audio decoding may comprise MPEG 1 level 3 decoding, and video decoding may comprise MPEG 2 decoding.

In an embodiment according to the present invention, the digital audio components may be decoded by an audio decoder 530, wherein after decoding the digital audio components, the audio components may be converted to analog signals by a digital to audio converter unit 540. After conversion from digital to analog, the analog audio signal 545 may be transmitted to a playback device (e.g., a speaker or speaker system), described below with respect to FIG. 6.

In an embodiment according to the present invention, the video components may be decoded by a video decoder 550, wherein after decoding, the digital video components may be transmitted to a video display engine 560a or a holograph display engine 560b, as desired.

In an embodiment according to the present invention, after processing in the video or holograph display engine, 560a and 560b, respectively, as desired. The video/holograph output signal 575 may be transmitted to one of a video display monitor, a video projection unit, or to a holograph projection unit, described below with respect to FIG. 6. In an embodiment according to the present invention, the audio output signal 545 and the video/holograph output signals may be transmitted separately, or alternatively be combined prior to transmission to the A/V display system 150 as illustrated in FIG. 1.

FIG. 6 is a pictorial representation of an audio and visual (A/V) display system 600 in accordance with an embodiment of the present invention. In an embodiment according to the present invention, the A/V display system 600 (150 in Figure) may receive a combined decoded holograph/video output signal 575 and decoded audio output signal 545 from the A/V decoding system 500, as illustrated in FIG. 5. In an embodiment according to the present invention, the decoded holograph/video output signal 575 and decoded audio output signal 545 may be received separately from the A/V decoding system 500.

In an embodiment according to the present invention, the holograph/video output signal 575 may be re-combined with the audio output signal 545 for transmission to the A/V display system 600, or alternatively, the signals may be transmitted separately to the A/V display system 600.

In an embodiment according to the present invention, at the A/V display system, the combined or separate holograph/video and audio signals, 575 and 545, respectively, may be immediately transmitted for playback, or alternatively may be transmitted to a storage media 660 for storage and later playback. The storage media 660 may comprise a stationary storage media device, such a computer hard drive, or alternatively may comprise a mobile storage media device, such as a CDROM, DVDROM, floppy disk, etc.

In an embodiment according to the present invention, the holograph/video and audio signals, 575 and 545, respectively, combined or separately, may be transmitted from the A/V decoding system 500 to a demultiplexer (DEMUX) 610 where the signals are accumulated and organized for transmission to A/V display chamber 630 or to the storage media device 660.

In an embodiment according to the present invention, the A/V display chamber 630 may comprise a spherical A/V display chamber 630, similar to the spherical A/V capture chamber 230, as illustrated in FIG. 2. In another embodiment according to the present invention, the A/V display chamber 630 may be rectangular, square, elliptical, or some other shape, as desired. For example, the A/V display chamber may be a room or a stage.

In another embodiment according to the present invention, the A/V display chamber 630 may comprise at least one or a plurality of video display monitors for displaying the video output signal 575 and the audio output signal 545.

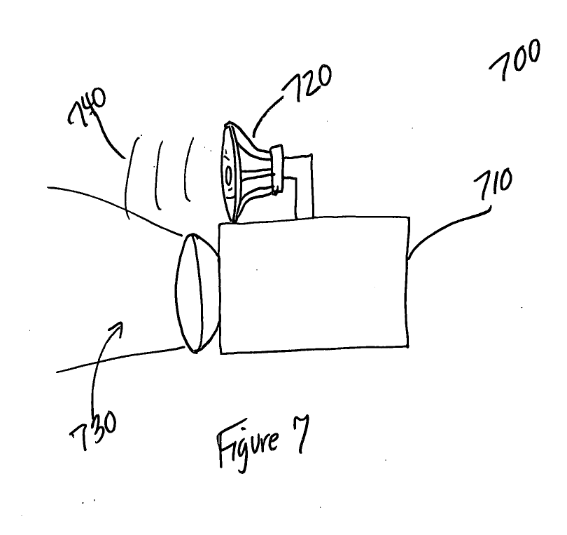

In an embodiment according to the present invention, the A/V display chamber 630 may comprise a plurality of A/V display units 640 optimally distributed around the circumference of the interior surface of the A/V display chamber 630. The A/V display units will be described in detail below with respect to FIG. 7.

In an embodiment according to the present invention, the A/V information being displayed at the A/V display chamber 630 may comprise audio information and video/holographic information directed and focused upon a center region of the A/V display chamber 630. The holograph/video and audio information may be transmitted from the DEMUX 610 via a plurality of wires 620 or wirelessly, as desired.

In an embodiment according to the present invention, the focused projection of the audio/video/holographic information produces a 3-dimensional surrounding visual and 3-dimensional surrounding audio representation 666 of the projected subject 650. The projected subject 650 may be the identical subject 250 as illustrated in FIG. 2, from which the audio and visual information was captured in the A/V capture chamber 230, as illustrated in FIG. 2.

In an embodiment according to the present invention, the projected holographic/video light information from the plurality of video/holographic projector units interacts forming a 3-dimensional virtual reality zone/region 666 through propagation/cancellation, constructive and destructive interference, etc., of the projected holographic/video light information arriving at the projection zone/region 666 from the plurality of angles around the entirety of the A/V display chamber 630 simultaneously.

In an embodiment according to the present invention, the projected holographic/video information is focused and projected from every corresponding angle and zone/region of projection identically as the A/V information that was captured from corresponding zones/regions of acquisition by the A/V capture units 240 of A/V capture chamber 230, as illustrated in FIG. 2.

FIG. 7 is a pictorial representation of an audio/visual (A/V) display unit 700 in accordance with an embodiment of the present invention. The A/V display unit 700, also referred to as reference number 640 with regard to FIG. 6, may comprise a video/holographic projection unit 710 for projecting holographic/video light information to the projection/display zone/region 666, as illustrated in FIG. 6.

In an embodiment according to the present invention, the projection unit 710 may be a video projection unit projecting light energy video information 730 to a location corresponding to the identical location in the A/V capture chamber 230 where the light energy video information 730 was captured.

In an embodiment according to the present invention, a plurality of video projection units may be arranged and deployed about the circumference of the interior of the A/V display chamber 630. The video projection units may be focused to project respective light video information 730 to respective corresponding zones/regions of projection creating a 3-dimensional virtual reality visual representation 666 of the subject 650, as illustrated in FIG. 6.

In an embodiment according to the present invention, the projection unit 710 may comprise a laser holographic projection unit projecting laser holographic light energy information 730 to a location corresponding to the identical location in the A/V capture chamber 230 where the light energy information was acquired/captured.

In an embodiment according to the present invention, a plurality of laser holographic projection units may be arranged and deployed about the circumference of the interior of the A/V display chamber 630. The plurality of laser holographic projection units may be focused to project their respective laser holographic light information 730 to their respective corresponding zones/regions of projection creating a 3-dimensional virtual reality holographic representation of the subject 650, as illustrated in FIG. 6.

In an embodiment according to the present invention, A/V display unit 700 may also comprise an audio playback unit 720. The audio playback unit 720 may comprise a speaker, or a plurality of speakers forming a speaker system. The audio playback unit 720 may project audio information 740 (sound wave energy corresponding to the identical location in the A/V capture chamber 230 where the audio information was acquired/captured.

In an embodiment according to the present invention, a plurality of audio playback units 720 may be arranged and deployed about the circumference of the interior of the A/V display chamber 630. The plurality of audio playback units 720 may be focused to project their respective audio information 740 to their respective corresponding zones/regions of playback creating a 3-dimensional virtual reality audio representation of the subject's 650 sound information and speech.

In an embodiment according to the present invention, the audio and holograph/video display/playback devices may be combined and arranged together, as illustrated in FIG. 7. In another embodiment according to the present invention, the audio playback unit 720 may be disposed at a different location than the holograph/video display unit 710.

In an embodiment according to the present invention, for each and every audio capture unit deployed in the A/V capture chamber 230 illustrated in FIG. 2, there is a corresponding audio playback unit deployed in the A/V display chamber 630 illustrated in FIG. 6.

Additionally, the location of a first audio capture unit in the A/V capture chamber 230 and the location of the corresponding first audio playback unit deployed in the A/V display chamber 630 are identical with respect to the subject 250 that audio information is being acquired from and the subject 650 in which the audio information is 3-dimensionally virtually recreating.

In an embodiment according to the present invention, for each and every video capture unit deployed in the A/V capture chamber 230 illustrated in FIG. 2, there is a corresponding holographic/video projection unit deployed in the A/V display chamber 630 illustrated in FIG. 6.

Additionally, the location of a first video capture unit in the A/V capture chamber 230 and the location of the corresponding first holographic/video projection unit deployed in the A/V display chamber 630 are identical with respect to the subject 250 that visual information is being acquired and the subject 650 that the holographic/video projection units are 3-dimensionally virtually recreating.

The holographic/video projection zone/region 666 may also be arranged such that the holographic/video display zones/regions of each adjacent holographic/video projection unit at least overlaps slightly the display zones/regions of adjacent holographic/video projection units.

In an embodiment according to the present invention, additional A/V information may also be submitted to the DEMUX 610 associated with A/V display system 600 and combined with the A/V information being projected and played back. The additional A/V information may be stored and transferred from an ancillary storage media device, such as a computer hard drive, for example. The additional A/V information may comprise one or more of music, graphs, pictures, tables, documents, backgrounds, and other information, etc., as desirable, to be included in the A/V display transmission.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of broadcasting multidimensional virtual reality audio and visual information, the method comprising:
acquiring audio and visual information from a plurality of acquisition angles in a three dimensional space;
processing the acquired audio and visual information for transmission;
receiving the processed audio and visual information; and
projecting the audio and visual information in a multidimensional virtual form from a plurality of projections angles in three dimensional space.

2. The method according to claim 1, further comprising:
storing the audio and visual information;
communicating the audio and visual information via a communication network;
acquiring sound information surrounding and emanating from a subject from a plurality of angles around the subject;
acquiring visual information surrounding and emanating from the subject, wherein visual information comprises visual features of an entirety of an exterior surface of a subject are acquired multidimensionally; and
producing a multidimensional surrounding visual representation and a multidimensional surrounding audio representation of a projected subject, wherein the projected subject is identical to a subject from which audio and visual information was previously acquired.

3. The method according to claim 1, wherein processing the audio and visual information further comprises:
projecting holographic information from a plurality of holographic projector units interact to form a multidimensional virtual reality region through at least one of light propagation, light cancellation, constructive interference, and destructive interference, from a plurality of angles simultaneously; and
focusing and projecting holographic information to a zone of projection, wherein holographic projection units project holographic information to a location corresponding to an identical location where visual information was captured, creating a multidimensional virtual reality representation of the subject.

4. The method according to claim 1, wherein processing the audio and visual information further comprises at least one of encoding, decoding, compressing, and decompressing the audio and visual information, and wherein processing further comprises audio encoding and decoding and visual encoding and decoding, wherein audio encoding and decoding comprises MPEG 1 level 3 processes and visual encoding and decoding comprises MPEG 2 decoding processes.

5. A method of acquiring multidimensional audio and visual (A/V) information, the method comprising acquiring A/V information from a multidimensional acquisition zone, the multidimensional acquisition zone comprising a substantially continuous three dimensional field of capture, wherein acquiring A/V information further comprises capturing A/V information from a plurality of angles at discrete positions in three dimensional space.

6. The method according to claim 5, further comprising:
processing the captured A/V information for transmission, wherein processing the captured A/V information comprises at least one of encoding and compressing the captured A/V information;
communicating the A/V information via at least one communication network;
storing the captured A/V information in at least one of a plurality of storage media devices;
acquiring A/V information surrounding and emanating from the subject via a plurality of A/V receiver units in the A/V capture chamber, the A/V receiver units comprise at least one of a visual capture device and an audio capture device, the visual capture device comprises at least one video camera and the audio capture device comprises at least one microphone, the audio capture device and the visual capture device are at least one of connected devices and separate devices;
deploying the plurality of A/V receiver units about an interior surface of the A/V capture chamber and acquiring the A/V information from a plurality of angles around the subject;
focusing the A/V receiver units upon a capture acquisition region comprising a center of an interior of the A/V capture chamber, the A/V capture chamber has a shape comprising at least one of spherical, rectangular, square, and ovoid.; and
focusing each A/V receiver unit upon a portion of the capture acquisition region, and overlapping each adjacent A/V receiver unit acquisition region at least partially, and acquiring A/V information from each A/V receiver unit's acquisition region and overlapping portions of adjacent A/V receiver units' acquisition regions.

7. The method according to claim 5, wherein processing captured audio and visual information further comprises encoding the audio information and encoding the visual information, wherein encoding the audio information comprises applying MPEG 1 level 3 encoding processes to the audio information and encoding visual information comprises applying MPEG 2 visual encoding processes to the visual information.

8. The method according to claim 5, further comprising combining additional ancillary A/V information with the acquired A/V information, wherein the additional ancillary A/V information comprises at least one of music, graphs, pictures, tables, documents, and backgrounds.

9. A method of displaying and projecting multidimensional audio and visual (A/V) information, the method comprising:
projecting A/V information into a multidimensional display region, the multidimensional display region comprising a uniform field of focused projection, wherein displaying A/V information further comprises projecting A/V information from a plurality of discrete projection angles located at a plurality of locations in three dimensional space;
processing received A/V information, wherein processing received A/V information comprises at least one of decompressing and decoding A/V information, wherein processing A/V information further comprises audio decoding and video decoding, wherein audio decoding comprises MPEG 1 level 3 decoding processes and video decoding comprises MPEG 2 decoding processes;
projecting the A/V information in a multidimensional virtual form into a corresponding multidimensional projection zone;
storing A/V information in a plurality of storage media devices; and
receiving A/V information from at least one communication network.

10. The method according to claim 9, wherein displaying the A/V information comprises using an A/V display chamber, wherein the A/V display chamber has a shape comprising at least one of spherical, rectangular, square, and ovoid, and wherein the A/V display chamber is selected from one of a room and a stage.

11. The method according to claim 9, further comprising:
processing visual information, wherein processing visual information further comprises at least one of enabling a video display engine to transform the visual information into a video output signal and enabling a holographic display engine to transform the visual information to a holographic output signal;
transmitting one of the video output signal to a video projection unit and the holographic output signal to a holographic projection unit;
processing audio information and transmitting the audio information via an audio output signal to an audio projection unit; and
receiving and projecting one of a combined holographic and audio output signal, a combined video and audio output signal, a separate holographic output signal and audio output signal, and a separate video output signal and audio output signal received from one of the A/V decoding system and a storage system.

12. The method according to claim 11, wherein receiving and projecting the audio and visual information is performed by a plurality of video projection units for projecting and displaying the video output signal and a plurality of audio projection units for projecting the audio output signal, wherein a plurality of A/V display units are distributed around an interior surface of an A/V display chamber.

13. The method according to claim 12, further comprising focusing and directing audio information and projected holographic information upon a center region of the A/V display chamber producing a multidimensional surrounding visual and multidimensional surrounding audio representation of a projected subject.

14. The method according to claim 13, further comprising:
projecting holographic information from a plurality of holographic projector units forming a multidimensional virtual reality region through at least one of light propagation, light cancellation, constructive interference, and destructive interference, arriving from a plurality of angles around an entirety of the A/V display chamber simultaneously;
focusing and projecting the holographic information from a plurality of discrete angles and overlapping zones of projection;
projecting holographic information to the zone of projection via a plurality of holographic projection units, wherein the holographic projection units project holographic information to a location creating a multi-dimensional virtual reality representation of a subject; and
playing received audio information via a plurality of audio playback units, each of the audio playback units comprising at least one speaker, the audio playback units focusing and projecting audio information to create a multidimensional virtual audio representation of a subject's sound information and speech.

15. A multidimensional virtual reality audio and visual (A/V) system comprising:
A/V capture system for acquiring audio and visual information from a multidimensional acquisition zone; and
A/V encoding system, the A/V encoding system processing the acquired A/V information for transmission.

16. The system according to claim 15, further comprising:
a plurality of storage media devices for storing A/V information comprising at least one of a stationary storage device and a mobile storage device; and
the system being communicatively coupled to at least one communication network, and wherein A/V information is communicated between one of the A/V encoding system and at least one of a plurality of storage media devices for storing audio and visual information, the A/V information captured by the A/V capture system is at least one of encoded and compressed by the A/V encoding system, the A/V capture system comprises an A/V capture chamber, the A/V capture chamber has a shape comprising at least one of spherical, rectangular, square, and ovoid, the A/V capture chamber is adapted to acquire sound information surrounding and emanating from a subject and visual information surrounding and emanating from the subject via a plurality of A/V receiver units, the plurality of A/V receiver units are deployed about an interior surface of the A/V capture chamber to acquire sound and visual information from all possible angles around the subject, the A/V receiver units are focused upon a capture acquisition region comprising a center of an interior of the A/V capture chamber.

17. The system according to claim 16, wherein each A/V receiver unit is focused upon a portion of the capture acquisition region, and each A/V receiver unit is arranged to acquire A/V information from an A/V receiver unit's acquisition region and a region at least partially overlapping adjacent A/V receiver units' acquisition regions, the A/V receiver units comprise at least one of a video capture device and an audio capture device, the audio capture device and the video capture device are at least one of connected devices and separate devices, the video capture device comprises at least one video camera and the audio capture device comprises at least on microphone, wherein visual features of an entirety of an exterior surfaces of a subject are captured by the plurality of A/V receiver units in combination multidimensionally, and audio information emanating from the subject are captured by the plurality of A/V receiver units in combination multidimensionally, additional A/V information is combined with the acquired A/V information from the A/V receiver units, wherein the additional A/V information comprises at least one of music, graphs, pictures, tables, documents, and backgrounds, the A/V encoding system processing received audio and visual information further comprises audio encoding and video encoding, wherein audio encoding comprises MPEG 1 level 3 encoding processes and video encoding comprises MPEG 2 decoding processes.

18. A multidimensional virtual reality audio and visual (A/V) system comprising:
an A/V decoding system, the A/V decoding system processing received audio and visual information; and
an A/V display system, the A/V display system projecting the audio and visual information in a multidimensional virtual form in a corresponding multidimensional projection zone.

19. The multidimensional virtual reality A/V system according to claim 18, further comprising:
a plurality of storage media devices for storing audio and visual information, the storage media devices for storing audio and visual information comprise at least one of a stationary storage device and a mobile storage device, the A/V system being communicatively coupled to at least one communication network, and A/V information being communicated between one of the A/V decoding system and at least one of the plurality of storage media devices for storing A/V information, the A/V decoding system comprising audio decoding and video decoding, the audio decoding comprising MPEG 1 level 3 decoding and the video decoding comprising MPEG 2 decoding, the A/V decoding system further comprising a video display engine transforming the visual information to a video output signal, the video output signal being transmitted to a video projection unit, the A/V decoding system further comprising enabling a holographic display engine transforming the visual information to a holographic output signal, the holographic output signal being transmitted to a holographic projection unit, the A/V decoding system further comprising audio information transmitted via an audio output signal, the audio output signal being transmitted to an audio projection unit, the audio output signal and one of a video output signal and a holographic output signal being transmitted one of combined together and separately, the A/V display system being adapted to receive one of a combined holographic and audio output signal, a combined video and audio output signal, a separate holographic and audio output signals, and a separate video and audio output signals from one of the A/V decoding system and a media storage device, the A/V display system comprising an A/V display chamber, the A/V display chamber having a shape comprising one of spherical, rectangular, square, and ovoid, and the A/V display chamber further comprising one of a room and a stage, the A/V display chamber comprising a plurality of video projection units for projecting the video output signal and a plurality of audio projection units for projecting the audio output signal, the A/V display chamber comprising a plurality of A/V display units distributed around an interior surface of the A/V display chamber, the audio information and the holographic information being directed and focused upon a center region of the A/V display chamber producing a multidimensional surrounding visual and multidimensional surrounding audio representation of a projected subject, the projected subject being identical to a subject from which the A/V information was captured in an A/V capture chamber, the projected holographic information from a plurality of holographic projector units interact forming a multidimensional virtual reality region through at least one of light propagation, light cancellation, constructive interference, and destructive interference, arriving from a plurality of angles around an entirety of an interior of the A/V display chamber simultaneously, the projected holographic information being focused and projected from a plurality of angles and zones of projection, the A/V display unit comprising a plurality of holographic projection units projecting holographic information to the zone of projection, wherein the holographic projection units project holographic information creating a multidimensional virtual reality representation of the subject, the A/V display unit comprising a plurality of audio playback units, the audio playback units comprising at least one speaker, the audio playback units projecting audio information to create a multi-dimensional virtual audio representation of a subject's sound information and speech.

20. A multidimensional virtual reality audio and visual (A/V) system comprising:
an A/V capture system for acquiring audio and visual information from a multidimensional acquisition zone;
an A/V encoding system, the A/V encoding system processing the acquired audio and visual information for transmission;
an A/V decoding system, the A/V decoding system processing received audio and visual information; and
an A/V display system, the A/V display system projecting the audio and visual information in a multidimensional virtual form to a corresponding multidimensional projection zone.

21. The multidimensional virtual reality audio and visual system according to claim 20, further comprising:
a plurality of storage media devices for storing audio and visual information the storage media devices for storing audio and visual information comprising at least one of a stationary storage device and a mobile storage device, the A/V system being communicatively coupled to at least one communication network, the A/V information being communicated between one of the A/V encoding system, the A/V decoding system, and at least one of a plurality of storage media devices for storing audio and visual information, the A/V capture system and the A/V display system being one of located at different geographic locations and co-located at a plurality of different geographic locations, additional A/V information is combined with acquired A/V information from the A/V receiver units, the additional A/V information comprises at least one of music, graphs, pictures, tables, documents, and backgrounds, the A/V decoding system processing received A/V information further comprises audio decoding and video decoding, the audio decoding comprising MPEG 1 level 3 decoding processes and the video decoding comprising MPEG 2 decoding processes, the A/V decoding system further comprising a video display engine transforming the visual information into a video output signal, the video output signal being transmitted to a video projection unit, the A/V decoding system further comprising a holographic display engine transforming the visual information into a holographic output signal, the holographic output signal being transmitted to a holographic projection unit, the A/V decoding system further comprising transforming the received audio information into an audio output signal and transmitting the audio output signal via at least one communications network, the audio output signal being transmitted to an audio projection unit, the audio output signal and one of a video output signal and a holographic output signal being transmitted one of combined together and separately, the A/V display system receiving one of a combined holographic and audio output signal, a combined video and audio output signal, a separate holographic and audio output signal, and a separate video and audio output signal from one of the A/V decoding system and a media storage device, the A/V display system comprising an A/V display chamber, the A/V display chamber having a shape comprising one of spherical, rectangular, square, and ovoid, and the A/V display chamber further comprises one of a room and a stage, the A/V display chamber comprising a plurality of video projection units for projecting the video output signal and a plurality of audio projection units for projecting the audio output signal, the A/V display chamber comprising a plurality of A/V display units distributed around an interior surface of the A/V display chamber, audio information and holographic information being directed and focused upon a center region of the A/V display chamber producing a multidimensional surrounding visual representation and a multidimensional surrounding audio representation of a projected subject, the projected subject being identical to a subject from which the A/V information was previously captured in an A/V capture chamber, projected holographic information from a plurality of holographic projector units interact forming a multidimensional virtual reality region through at least one of light propagation, light cancellation, constructive interference, and destructive interference, arriving from a plurality of angles around an entirety of the A/V display chamber simultaneously, the projected holographic information being focused and projected from a plurality of angles and zones of projection identically as acquired A/V information that was captured from respective corresponding angles and zones of acquisition by the A/V receiving units of the A/V capture chamber, the A/V display unit comprising a plurality of holographic projection units projecting holographic information to the zone of projection, the holographic projection units project holographic information to a location corresponding to an identical location in the A/V capture chamber where visual information was captured, and creating a multidimensional virtual reality representation of the subject, the A/V display unit comprising a plurality of audio playback units, the audio playback units comprising at least one speaker, the audio playback units projecting audio information to an identical location in the A/V display chamber where the corresponding audio information was acquired in the A/V capture chamber, the plurality of audio playback units being focused to project audio information creating a multidimensional virtual audio representation of a subject's sound information and speech.
